(19) United States
(12) Patent Application Publication
(10) Pub. No.: US 2012/0158726 A1
(43) Pub. Date: Jun. 21, 2012

(54) Method and Apparatus For Classifying Digital Content Based on Ideological Bias of Authors

(76) Inventors: Timothy MUSGROVE, Morgan Hill, CA (US); Robin WALSH, San Francisco, CA (US); Peter RIDGE, San Jose, CA (US)

(21) Appl. No.: 13/311,210

(22) Filed: Dec. 5, 2011

Related U.S. Application Data
(60) Provisional application No. 61/419,554, filed on Dec. 3, 2010.

(51) Int. Cl. G06F 17/30

(52) U.S. Cl. 707/737; 707/E17.089

(57) ABSTRACT

A method and apparatus for classifying a collection of digital documents based on ideological bias of authors. At least a portion of text of a digital document is received and parsed. Pairs of specific features text having specified relationships are detected. The pairs are then mapped to an ideological bias, based on an ideological bias ontology for example. Various actions can be taken on the digital documents based on the determined ideological bias.

### RELATED APPLICATION DATA

This application claims priority to Provisional Patent Application Ser. No. 61/419,554, filed on Dec. 3, 2010, the disclosure of which is hereby incorporated by reference in its entirety.

### BACKGROUND

The curation of content includes, in large part, the ongoing job of sorting and filtering out from a mass of documents the subset that relates to a particular area of interest. This is an important aspect of the world of information in general and of the World Wide Web and other large document collections in particular. Many of the best websites, blogs, community sites, news aggregators, and the like are comprised in large part by the results of someone, with or without the assistance of automated tools, having curated content from hundreds of sources, gathering and organizing a handful of articles each day that revolve around a particular stance or topic, or otherwise satisfying specified criteria.

The task of content curation, in many cases, is unmanageable when viewed from an editorial perspective, either because there is just too much content to read through on a daily basis, or because the desired type of content is so sparse that finding it is like “looking for a needle in a haystack.” There are a number of tools that may be used to assist the human curator in the content identification task, such as topic classifiers, named entity extractors, automated taggers, and sentiment analyzers. These are useful for some of the simpler types of curation, such as merely gathering those news articles that relate in any way to a specific topic, such as the New York Yankees (e.g. for a fan site). However, for many of the more subtle and more valuable types of curation, these tools do not suffice.

It is well known to automate the process of determining “sentiment” of articles. Sentiment pertains to the specific reaction of the author in the individual article. For example, whether or not the author viewed a product favorably in a product review or favors a specific legislative proposal.

For example U.S. Published Patent Application 2007/0255553 A1 discloses extracting evaluative opinions of, for example, products in the marketplace. This reference is directed to extracting individual statements of opinion, i.e., sentiment, toward a product from unstructured text.

Similarly, U.S. Pat. No. 7,249,312 discloses assigning singular features in a linear regression model as indicating or contra-indicating an attribute for the purpose of determining sentiment. This reference discloses a machine learning method that yields a vector of many singular features, with weights, that it determines are correlated statistically from a training set. In such as system, it is particularly difficult to understand why the training set yielded a particular feature vector, or what parts of the vector drove the final classification.

### BRIEF DESCRIPTION OF THE DRAWINGS

Disclosed embodiments are described through the following drawings in which:

FIG. 1 is a computer architecture of an embodiment;

FIG. 2A is an example of an ideological bias ontology;

FIG. 2B is another example of an ideological bias ontology;

FIG. 3 is a flowchart of a method of an embodiment;

FIG. 4 is a screenshot showing the results of the method when used to curate content on a web site;

FIG. 5. is a screenshot of a content management system utilizing the embodiment; and

FIG. 6. is a layout of a configuration form for adjusting the evaluation architecture of the embodiment.

While systems and methods are described herein by way of example and embodiments, those skilled in the art recognize that systems and methods of the invention are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Known systems are not adequate for curating collections of articles and other digital content because they fail to identify the ideological biases of authors. For example, a blogger who wants to gather only politically conservative (or liberal, or libertarian) articles about the environment, or one who wants to gather dining reviews that specifically appeal to the college-age crowd, or the blogger who wants to gather only those news articles that are optimistic in tone. In other words, where a certain slant, such as interpretive stance, attitudinal tone, or ideological position (collectively referred to herein as “ideological bias”) is desired, basic classification and tagging tools fall short of automating, to any appreciable degree, the curator's massive task. Yet it is just such curation that is often the most needed, the most desired, and/or the most lucrative from the perspective of a publisher.

The disclosed embodiments use pairs of features in certain relations to indicate or contra-indicate a feature. This allows the embodiments to determine ideological bias of the author as opposed to merely sentiment. For example, mentioning “pollution” in an article does not mean there is an environmentalist ideological bias to a document. Similarly, mentioning “prevention” in an article does not mean that the document has an environmentalist ideological bias. But mentioning “prevention” in connection to “pollution”, and doing so approvingly, does indicate an environmentalist ideological bias. To determine ideological biases, require relations between a plurality of concepts to be recognized, not just unitary features.

Ideological bias detection is orthogonal to sentiment rather than correlating with sentiment. In particular, ideological bias is orthogonal to specific opinions on specific instances of things. A person's opinion that a certain bill before Congress is good or bad does not tell us right directly the ideological bias of that person. However, it that person is opposed to every bill that would spend taxpayers money to clean up the environment, and that person's primary reasons every time is that they think we are overtaxed, then an ideological bias that can be identified.

While most content networks can find a feasible way to automate (or partly automate) the gathering of articles around a given topic, the gathering of only those with a certain ideological bias takes a large investment in staff who can exercise particular editorial care. The disclosed embodiments separate texts that have a high probability of exhibiting the desired ideological bias, as defined by a combination of entity types and their characteristics or relations within a domain. A score representing the confidence level assigned to one or more ideological biases can be determined. Also, other metadata can be generated to help the curator in organizing documents and placing them in their proper context.

It is assumed that a large supply of candidate digital documents is received by, for example, one of the following methods:
A large repository or archive of candidate documents may be available or accessible
A white list of appropriate and relevant publishers may be known, or may be readily established
A grey-list approach may be used, wherein we begin with a white list and then expand to other publications referred by those in the white list a sufficient number of times
A search engine (or plurality thereof) may be used to find candidate documents by looking for words representing very general and high-level topics in the area of interest
A stream of incoming UGC (user-generated content) may be available, e.g. on a high-traffic website that lets its millions of users submit comments and letters, etc.
Any combination of the above approaches.

In a given digital document, there may be some sections that comprise the target content for analysis, and other sections that do not because they are obviously not relevant to the process. The most obvious example is that of web pages, where ads, navigation bars, copyright notices, etc. need to be ignored. DOM (document object modeling) and/or similar methodologies that are extant in the literature may be used for this purpose in a known manner.

Also, there may be genres, types or forms of content that the administrator wishes to ignore, such as perhaps letters to the editor, user comments, and opinion columns in a use case where only standard journalistic content is desired. Thus, the appropriate sections of the appropriate types of content from the appropriate sources are established as input and are received by the analysis architecture of the disclosed embodiment.

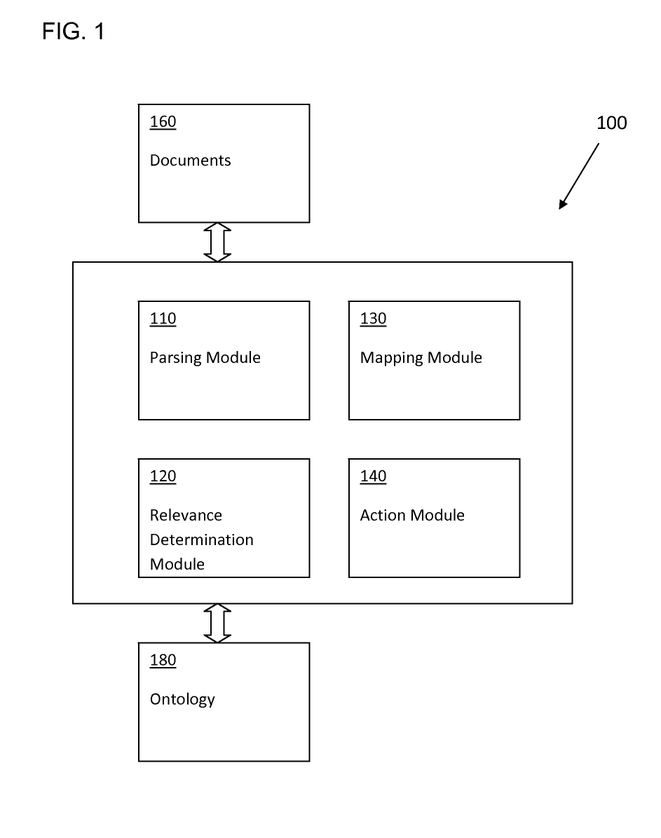

FIG. 1 illustrates analysis architecture 100 of an embodiment. Analysis architecture 100 can be constructed of one or more computing devices having software to define functional modules. Analysis architecture 100 includes at least one tangible memory device and at least one processor. The at least one memory device has instructions stored thereon that, when executed by the processor, cause the processor to carry out the disclosed functions. The modules of the embodiment are segregated by function for ease of description. However, the modules can be segregated in any manner and the term “module” is not intended to describe any discrete device and/or software portion. The modules of the embodiment include parsing module 110, relevance determination module 120, mapping module 130, and action module 140. Analysis architecture 100 functions in the manner described below and interacts with ontology 180 and documents 160 as described below.

An “interpretive stance” is operationally defined herein as having an interest in (or concern with) specified combinations of members of certain classes of entities and relationships thereof. Each said class constitutes a sub-domain of the particular ideological bias in question. For example a politically conservative stance within American politics could be specified to include taxes, tax cuts, climate change, abortion, legalization of marijuana, etc. as areas of concern. Some of the sub-domains into which these are organized, could be Fiscal Burdens (from the conservative standpoint): taxes, spending, entitlements, deficits, debts, etc., and Social Indulgences (again from the conservative standpoint): marijuana, pornography, prostitution, etc.

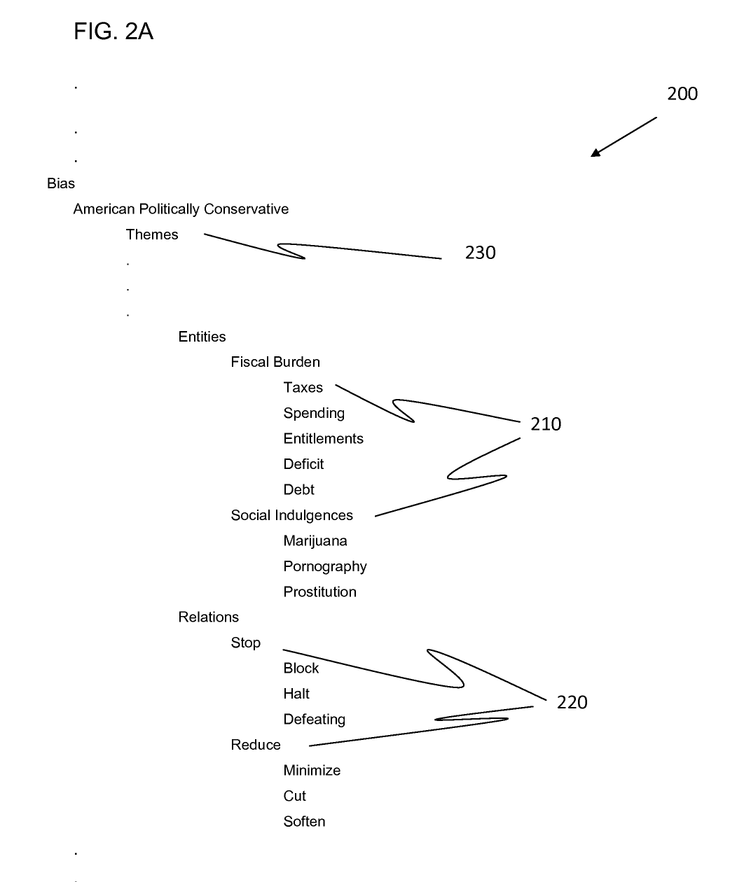

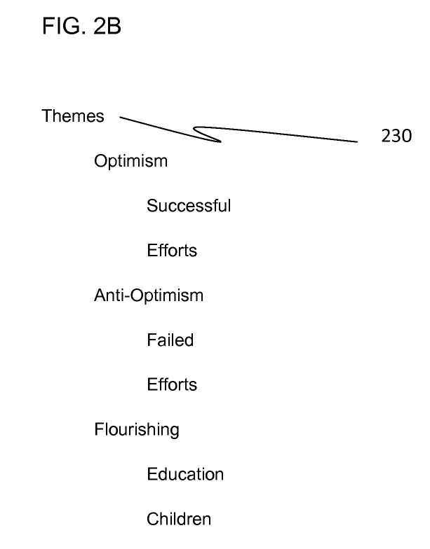

Some of the relations to these entities, organized also into sub-domains, could be, Stoppage: blocking, halting, defeating, stopping, etc., and Reduction: reducing, minimizing, cutting, softening, etc. and Support: financing, renewing, extending, bolstering, etc. These entities and relationships can be abstracted into a ideological bias ontology. For example, as illustrated in FIG. 2, ideological ontology 200 includes entity classes 210 and relation classes 220 associated with the ideological bias of “American Politically Conservative”. Each entity and relation has one or more terms associated therewith as sub elements. Also, ontology 200 can have multiple ideological biases and related entity classes and relation classes. Themes 230, discussed in greater detail below with respect to FIG. 2B, can also be used to determine ideological bias. Ontology 200 can be configured based on the desired outcome and the domain(s) of the documents as well as other considerations that will become apparent below.

Once the aforementioned sub-domains are established as an ontology, then in our example, the politically conservative stance may be partly defined as an interest in certain combinations of relation classes and entity classes, e.g. Stoppage of Social Indulgences and Reduction of Fiscal Burdens in combination. Of course, other entities and relations can be used to define a stance. These combinations of relation classes and entity classes are herein referred to as “valuations of entities” because taking an interest in one of them is deemed to be an expression of one's values. If someone wants to stop the legalization of marijuana, or support the increase of welfare entitlements, or protect the grey whale from extinction, then someone is taking a stance.

Strings of words that have a high probability of representing one or more of the entity valuations within the relevant domain can be extracted, from unstructured prose text in the digital documents, This can be done through configuration of a known semantic analysis tool that allows various roles or functions of entities to be detected in prose text. For example, a known Semantic Role Analyzer (SRA) can be used. In the embodiment, a known “function tagger” is used, which parses out specified functions played by entities within a sentence, e.g. finding a particular class of verbal or adjectival phrase attached to a particular class of noun. Alternatively, any of various semantic role parsers, such as thematic role parsers, thematic relation parsers, etc., with the appropriate extensions and configuration, as would be apparent to one of skill in the art, could be used. For example, the stock thematic roles that are pre-defined in a typical thematic role parser can be refined to provide satisfactory detection of the functional roles in question.

Parsing module 110 can initially parse received text from a digital document into sentences. The desired classes of entities and their pertinent relations can be defined in advance through ontology 200, for example. This allows analysis architecture 100 to evaluate the stance. The resulting output for a given sentence, if any, will be one or more normalized valuation(s) of a dynamically determined entity class of ontology 200. In other words, a variety of different surface vocabulary may reflect the same valuation. For example, for the valuation of “Improvement” there may have been “has improving”, “was seen to improve”, “is getting better”, “has been looking up”, etc. Unification of variations in inflection, derivation, synonymy, hyponymy, stemming and/or similar functions of semantic similarity can be employed.

It is of the very nature of an expression of human values, such as any form of interpretation, opinion, attitude, ideology, and the like, that they are constituted as binary oppositions. For every opinion there is a counter-opinion, for every preference there is its opposite, for every style there is one (or more) conflicting style(s).

Making the task of the analysis architecture more difficult is the fact that authors expressing opposing “slants” often talk so much about the same thing, in sometimes very similar language. As an example, American conservatives and liberals are likely to talk about wars, taxes, immigration, and other common issues. In fact, the two sides often quote and misquote, characterize and mischaracterize each other's positions. This means there may be bits of conservative-sounding verbiage in an overall liberal essay, and vice versa. For this reason, it is possible that the analysis architecture could be fooled into thinking an essay is of a conservative tone, when perhaps it is a liberal author, spending a great deal of “ink” in outlining his opponent's position, while nonetheless expressing his disagreement and ultimately his final, very liberal counter-opinion. In order to avoid the mistake of characterizing such an essay as conservative when it is not, the evaluator can optionally be configured to recognize both conservative and liberal ideological bias, such that the final scoring mechanism uses the presence of liberal ideological bias as a penalty that works against the final confidence score of the text's being conservative. In other words, both negative and positive evidence are detected in order to make the final determination of the Ideological bias of the text.

The analysis architecture determines a valuation which contributes to a score for a given stance that has been assigned by the curator. Each instance of a valuation is given a score based on a variety of factors that may indicate its prominence within the article, such as location in document (e.g. title, first paragraph, closing paragraph), textual formatting (e.g. bold, large font), etc. Scores for each instance of a valuation are combined into a valuation score, meaning the more times a valuation is detected in the article, the higher the overall score for the valuation will be. The valuation scores are combined, incorporating a curator-configurable score multiplier, to create the final scores for the stances to which the valuations are mapped. The valuation score aggregation takes into account several factors such as the length of the document, density of valuations, etc., in order to produce a score between 0 and 1 that reflects how well the document represents the stance overall. Normalization of the valuations is required, as noted earlier, in order to not unduly inflate stance subscores if multiple instances of essentially the same valuation with different wording are detected throughout the article. The stance scores (also called “subscores”) are then combined using ratios configured by the curator to produce the final stance score. This final score can then be mapped to an ideological bias based on preset thresholds.

In the embodiment, the objective is to come up with a score(s) that pertain to the ideological bias in question. e.g. for OdeWire, we want a final score that roughly gauges “optimism”. An example of how the various sub-scores are combined algorithmically to reach a final score is set forth below. It is probable that a “theme” for a given source will be comprised of several domains, so the combination of <domain> scores of function tags that matched in a given document. Syntax for such expression will be done via a command map, with the following format:
.Scores=“odewire.com Optimism=1 Flourishing=0.3 Anti-Optimism_Margin=−0.3\;”

The above formula represents that Optimism scores are fully weighted, but that flourishing is roughly 30% as important as it being optimistic. And that up to 30% as much anti-optimistic language may be tolerated. In this case, many particular valuations count as optimistic, many as anti-optimistic. Further, some count as “human flourishing”. The latter are necessary to ensure the subject matter being indentified is of appropriate significance (relevance). In other words, some articles might be optimistic indeed, but pertaining to a trivial matter (such as how to perfectly cook microwave popcorn for the right amount of time using a particular model microwave). Thus only those articles that are not only, on balance, more optimistic than pessimistic, but also pertain to “flourishing” (e.g., education, health, international relations, the environment, economic prosperity), are given a high final score.

Another example of the final scoring algorithm works as follows:
1. Create a pie-slice score using the positive scores (PS).
2. Create a pie-slice score using the negative scores (NS).
3. The difference of PS−NS results in:
   PS>NS: the lack of NS results in a DTG (distance-to-goal) bonus to PS
   PS<NS: results in a penalty to PS in proportion with difference
4. A “balance” ratio is created using (TN/(TN+TP)), where TN=Total

Negative Score, TP=Total Positive Score (e.g. 0.3/1.6 in above example). The balance ratio is used as a simple multiplier to the score modification.

Hence, if you want to have more influence of the negative scores, just increase them all proportionately.

The disclosed embodiment addresses the enormous task of manual identification of content of a particular ideological bias. While the embodiment enables this process to be far more effective, prolific, time-efficient, and affordable, it does not necessarily supplant the human editorial “touch” within the process. The human curator can be very involved both in the early and late stages of the content analyzing procedure, as follows:
1. The curator will discuss with a knowledge editor the characteristics of the ideological bias that is desired by the curator.
2. The knowledge editor will then define the ideological bias in a way that is mappable to the curator's various stances within the overall ideological bias. For example, the ontology described above can be used.
3. The curator will also establish the content store, white list, or greylist which is to be utilized.

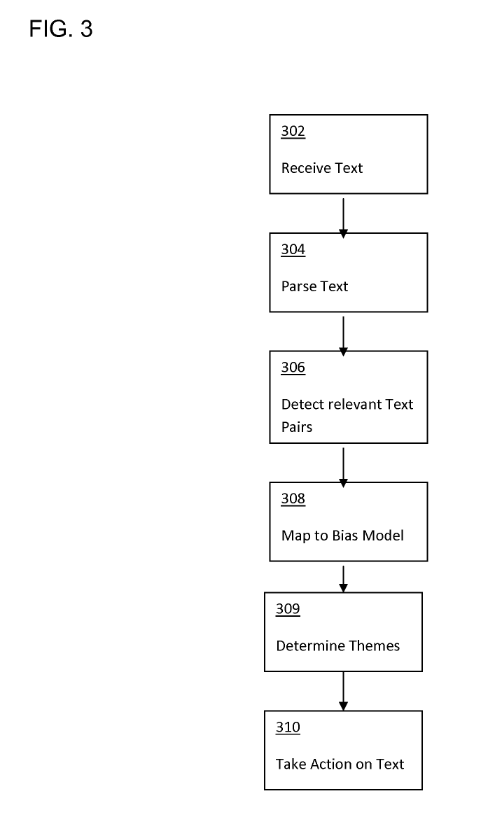

Once the embodiment has been configured by the curator as noted above, the embodiment will then run the ideological bias analysis process on each document. This process is illustrated in FIG. 3. In step 302, at least a portion of the text of any article is received. In step 304, the text is parsed in a known manner. In step 306, pairs of specific text features having the predefined relationships are detected. In step 308, the detected pairs are mapped to an ideological bias.

In step 309, Themes 230 (see FIG. 2) can be determined. As an example and with reference to FIG. 2B, in the test case described below, the objective is to determine an ideological bias of Optimism. FIG. 2B shows an example of a portion of an ontology in which entity-relation pairings are organized under themes 230. To determine Optimism, we can use three themes, Optimism, Anti-Optimism, and Flourishing. I this example, the relation-entity pairing Successful-Efforts can yield the theme optimism; The relation-entity pairing Failed-Efforts can yield the theme anti-optimism; and the relation-entity pairing Education-Children can yield the theme Flourishing.

In step 310, action is taken on the document based on the determined ideological bias. As discussed in detail below, the actions can be categorizing, publishing, queuing for review, discarding, or any other desired action.

The parsing of step 304 can include filtering out irrelevant content in a known manner, such as filtering out sections of a document based on the Document Object Model, or filtering out articles, blacklisted terms. Step 306 can include the entity valuation and scoring described below. Step 310 can include various actions which can be accomplished based on threshold levels of scores, as described below. For example, actions may include:
Auto-publishing a candidate article if its score is above a certain threshold
Holding a candidate article in pending status if its score is below a certain threshold
Allowing curators to publish an article that was held in pending status
Allowing curators to reject a published or pending article as inappropriate

Once the documents are processed by the evaluator, the knowledge editor may optionally wish to do any of the following, periodically, either manually or via appropriate machine-learning tools and technologies:
Examine any rejected articles with a view toward refining their definition and scoring of entity-valuations so that fewer false positives are created in the future
Examine any lower scoring articles that the curator nonetheless published, with a view toward creating any additional valuations that might have enabled the article to receive a legitimately higher score
Discuss with the curator items (a) and (b) above

Test Case:

In developing the embodiment a prototype was tested in creating a new website, called OdeWire.com. The primary purpose of this site is to bring together news articles of an optimistic ideological bias. The working tagline of the site is “news for intelligent optimists.” By requiring some Optimism themes and some Flourishing themes, and limiting Anti-Optimism themes, the embodiment finds the desired articles. The Flourishing theme is used to avoid false positives by tying success to a desirable outcome. Consider this example:
After many efforts and educational endeavors, I was finally successful in developing a better way to break into cars. My friends all say that they were able break into cars more quickly and thus make a better living.

This example has optimistic language and thus could trigger a false positive if the success is not tied to a desired outcome through the Flourishing Theme. Following are some of the news articles that were promoted to the site by the embodiment, each followed by the text snippets that helped it qualify for the intended ideological bias:
1. http://www.nytimes.com/2010/09/19/nyregion/19bloomberg.html: Bloomberg Pushes Moderates in National Races
   not bound by rigid ideology
   capable of compromise
   centrist problem solver
2. http://www.nytimes.com/2010/09/19opinion/19bono.html: M.D.G.'s for Beginners . . . and Finishers
   cutting hunger and poverty in half
   giving all girls and boys a basic education
   reducing infant and maternal mortality
   reversing the spread of AIDS
   more kids are in school thanks to debt cancellation
   lives have been saved
   battle against preventable disease
   tackle extreme poverty
   we've seen transformative results for millions of people
3. http://www.csmonitor.com/Environment/2010/0830/California-set-to-ban-plastic-bags: California set to ban plastic bags
   Environmental groups are strongly in favor
   our best opportunity to virtually eliminate the plastic bag pollution
   recycling of plastic bags grew 28 percent
4. http://www.guardian.co.uk/society/sarah-boseley-global-health/2010/sep/18/maternal-mortality-sierraleone: How to save women's lives—the lessons from Sierra Leone
   improved the lives of every single citizen
   the launch of nationwide free health care for pregnant mothers
   the beginnings of major improvement
   cleaning up our health care system
   leading the way in how to best save lives
   Get everyone on board
   Build a team
   save the lives of women and children
   a transparent system of procurement
5. http://www.guardian.co.uk/global/2009/jul/01/desmond-tutu-education-fund: Desmond Tutu asks G8 leaders to get world's children into school
   redouble their efforts to give a basic education to the 75 million children
   improve health in these countries
   cases of HIV could be prevented
   makes SRAII loans to the poor
   renew their commitment to the world's poorest children
   healthy, happy lives
   investing in education
   set up a global fund for education
   pledged in 2000 to help ensure that every child had access to primary education
   effort to provide a school place for every child
6. http://www.washingtonpost.com/wp-dyn/content/article/2010/09/16/AR2010091602595.html: Clinton turns history of controversial statements on Mideast into asset in talks
   her first stab at substantive Middle East diplomacy
   Both sides view her as an advocate
   prepared assiduously for the diplomacy
   peace negotiations
   reached out to her predecessors
   the answer to three dilemmas
7. http://www.washingtonpost.com/wp-dyn/content/article/2010/09/17/AR2010091701191.html
   putting aside their differences
   teaming up
   to chase a common goal
   they put aside their politics
   Netanyahu is currently in peace talks with Palestinian President
   hopes it will mark the beginning of a cultural “renaissance”
   create a model here on the field to get people to work together
8. http://www.mercurynews.com/green-energy/ci_{—}15955344
   plug-in hybrids that will be eligible for carpool stickers
   find ways to limit our carbon footprint
   a great incentive for car manufacturers to develop higher emission standards
   Upgrade to a plug-in car
   incentives on the next generation of cars
   cars that use even less petroleum
9. http://www.sfgate.com/cgi-bin/article.cgi?f=/n/a/2010/09/18/international/i064007D44.DTL
   halve the numbers of people in extreme poverty
   promised a new initiative
   number of new infections has fallen
   reducing hunger by nearly three-quarters
   halved their absolute poverty levels
   goal to eradicate poverty
10. http://www.slate.com/id/2267847/: The Unappreciated Power of Honor
   Power of Honor
   has driven moral progress
   Vast moral revolutions
   high-minded prophet
   embracing the revolutionary idea
   a new foundation for the whole of society
   good has, in fact, been done
   moral progress on the grandest of scales
   Quakers organized the earliest anti-slavery committees
   marathon anti-slavery meetings
11. http://www.salon.com/entertainment/movies/andrew_ohehir/2010/09/18/sheen_e stevez/index.html: Talk about God with Martin Sheen
   the potential to connect with soul-searching
   miracles began to happen instantly
   develop and discover things along the way
   beginning to focus on what's really important
   the beginning of community
   It's so deeply personal
   spirituality in this movie in an open-minded, non-cynical fashion
   Spirituality unites us
   People are looking for transcendence now more than ever
12. http://online.wsi.com/article/SB1000142405274870347090457549993380092964 8.html?mod=WSJ_WSJ_US_News 5
   Muslims Seek Unity at Summit
   to bring these factions together
   Grass-roots support is indeed building
   include prayer space for Jews, Christians and other religious groups
   a nondenominational interfaith space
   reached out to some neighborhood politicians for support
13. http://www.sfgate.com/cgi-bin/article.cgi?f=/c/a/2010/09/19/HO9H1FAJPB.DTL: Secrets to gardens that endure
   sustainable landscaping
   carefully maintained for productivity
   people fall in love with a garden
   buoying the spirits of people
   drought-tolerant plants
   Its aesthetics get spread within its culture
   new way of grappling with photography, beauty and gardening
14. http://www.sfgate.com/cgi-bin/blogs/stockdale/detail?entry_id=67965: Ten reasons to shop at a local farmer's market
   buy at a local farmers market
   Support Family Farmers
   Protect the Environment
   sustainable agriculture
   choices based on values that are important to you
   diversity (and biodiversity) of our planet
   Promote Humane Treatment of Animals
   animals that have been raised without hormones or antibiotics
   Connect with Your Community
   The market is a community gathering place
   a place to meet up with your friends
15. http://www.boston.com/news/science/articles/2010/09/19/winner_of_{—}5_million_au to_x_prize_took_unconventional_approach/: Winner of $5 million Auto X Prize took unconventional approach
   create fuel-efficient vehicles
   a battery-electric vehicle
   the enclosed battery-electric motorcycle
16. http://www.boston.com/business/technology/articles/2010/09/19/a wetlab could put mass in the lead in ocean energy race/: A ‘wetlab’ could put mass. In the lead in ocean energy race
   a tidal generator
   a prototype wind turbine
   Testing new renewable energy technologies
   the National Renewable Energy Innovation Zone
   the energy technologies of the future
   a greater number of marine energy technology companies
   a system to pull power from ocean swells
   hopes to test its wave energy technology
   test beds for ocean-based power generation
   deploy prototype wind turbines
17. http://www.independent.co.uk/news/education/education-news/oxford-expands-with-billionaires-16375m-gift-2083859.html: Oxford expands with billionaire's £75 m gift
   philanthropist is backing Europe's first major school of government
   approach issues such as climate change
   tackle health crises
   new skill set for dealing with public policy
   knowledge of climate change
   His donation is one of the largest by an individual
18. http://online.wsi.com/article/SB1000142405274870344060457549626152920762 0.html: Unfreezing Arctic Assets
   evidence of climate warming in the region
   polar research
   biological productivity
   greater cultural and economic kinship
   forging ties with its northern neighbors
   collaborate constantly on issues
   peaceful, stable borders
   a globally integrated 2050 world
   motivating renewed human settlement
   what makes civilizations work
   causes new civilizations to grow
   economic incentive
   beneficial climate change
   friendly neighbors
19. http://www.sfgate.com/cgi-bin/article.cgi?f=/c/a/2010/08/22/HOBM1ET424.DTL&ao=all: Radical homemakers reclaim the simple life
   reclaim the simple life
   An inspirational, grassroots movement is afoot
   to make the world a better place
   socially responsible, food-obsessed, eco-zealous
   a deeply personal and well-supported case
   sustainable agriculture
   community development
   honor their deepest dreams and values
   social justice
   subsistence farming
   frugal living
   practice an Emersonian life of simplicity, authenticity and self-reliance
   cleaner and less energy-consumptive enterprise
   a SRAII carbon ‘hoofprint,’
   meaningful to the next generation
   a refreshing change
   Pursuing this kind of redemptive work
   laying the groundwork for a home-based soap-making business
   fair-trade farmers
   A little perspective
20. http://www.telegraph.co.uk/property/greenproperty/8002146/Green-property-energy-efficient-libraries.html: Green property: energy-efficient libraries
   energy-efficient light bulbs
   allows Ashtead residents to experiment
   help members reduce their energy consumption
   eco laundry balls
   reducing energy and waste
   reduce their energy bills
   identify areas of energy waste
   selling eco gadgets
   found a wonderful, creative solution
21. http://www.ft.com/cms/s/2/70b48c90-b0b8-11df-8c04-00144feabdc0.html: Mudlarking: finders keepers
   very tranquil
   takes you away from the hustle
   the love of history
   You become part of the river community
   the pure excitement of getting to see something for the first time in centuries
   historic artefacts
   mudlarking is a revelation
   The thrill of amateur archeology
22. http://www.ft.com/cms/s/0/55bf60fe-bf90-11df-b9de-00144feab49a,dwp uuid=99683c1a-bf93-11df-b9de-00144feab49a.html: Big names see which way the wind is blowing
   Sustainability is now the key driver of innovation
   rethinking business models
   decision to “green” a company's products
   motherlode of organisational and technological innovations
   Green innovation has been one of the most striking trends
   reshaping their businesses along green principles
   launched its “ecomagination” initiative
   environmental goods
   energy-efficient lighting, wind turbines, eco-friendly paints
   green products, including energy-efficient lighting
   pressure from consumers, civil society groups
   trumpet their environmental credentials
   interest in green product innovation from big companies
   initiative to focus on greening its vast product portfolio
   reduce consumers' environmental footprints
   innovation experiment
   ideas that would revolutionise the power grid
   renewable energy
   “repurpose” existing technologies to solve environmental problems
23. http://www.globecampus.ca/in-the-news/globecampusreport/the-case-for-single-sex-it-lets-girls-be-girls-and-boys-be-boys/: The case for single-sex: IT lets girls be girls and boys be boys
   lessons that can be better tailored
   gradually gaining confidence
   improved confidence
   less pressure to “be cool,”
   environment that encourages children to take risks and go for it and not worry
   having deep interests is what's considered cool
   opportunities to socialize and collaborate
24. http://www.economist.com/node/16990766: Invisible carbon pumps
   a surprising ally in the fight against climate change
   a whole new “sink” for carbon dioxide
   keeps carbon out of the atmosphere
   understand the Earth's carbon cycle
   effect on the climate
   a novel way to extract CO2 from the atmosphere
   combat climate change
   powerful ally in the fight against global warming
25. http://www.forbes.com/2010/07/29/annamox-bacteria-worrell-technology-breakthroughs-wastewater.html: Washing The Water
   make recycling water more powerful and efficient
   water recycling systems
   drastically reduce water use
   eliminate sewer discharge
   recycle wastewater by filtering it
   would require very little energy
26. http://www.walruSRAgazine.com/articles/2010.10-frontier-human-nature
   organics or recyclables
   first in Canada to initiate curbside composting
   a waste-conscious community
   recycling and particularly composting rates jumped
   care about these issues enough to make changes
   raise the visibility of eco-friendly behaviours
   launching the country's first community-wide recycling pilot project
   today recycling is a domestic ritual
   groundbreaking utility billing system
   rewards the lowest consumers
   the contemporary environmental movement
   recycling and composting rates are high
   tangible results in terms of land use and greenhouse gas emissions
27. http://www.csmonitor.com/Business/Latest-News-Wires/2010/0919/Fuel-efficient-vehicles-Three-cars-share-10-million-prize : Fuel-efficient vehicles: Three cars share $10 million prize
   Fuel-efficient vehicles
   the next generation light car
   ethanol-capable engine
   innovations in aerodynamics and the use of lightweight materials
   a two-seat electric car
   electric mini-car
28. http://mondediplo.com/2010/09/15avatar: Avatar activism
   a participatory approach to world activism
   environmentalists embraced Avatar
   epic piece of environmental advocacy
   directing attention to the rights of indigenous people
   healthy scepticism towards the production of popular mythologies
   creation for their own communicative purposes
   attempts to regain lands
   an empowered image of their own struggles
   call attention to the plight
   Participatory culture
   draw emotional power from its engagement with stories
   solidarity with the Iranian opposition party
   repurposing pop culture towards social justice
   participatory culture
   Shared narratives provide the foundation
   culture gets created
   building a grassroots infrastructure
   sharing their perspectives on the world
29. http://motherjones.com/road-trip-blog/2010/09/schemes-dreams-earthships-new-mexico: Greetings, Earthships
   live entirely to almost-entirely off the grid
   reduce waste to an absolute minimum
   water filtration system
   totally changed my life
   perfect for the commune
30. http://www2.macleans.ca/2010/09/16/power-to-the-people/: Is public data the future of governance
   make the city cleaner, healthier and more efficient
   principles of free information, collaboration and connection
   simpler, cheaper and clever
   theories like open data and open government
   government is not only more accountable and transparent
   citizens are empowered to engage in public policy
   create their own solutions
   help for its green city agenda
   find available child care in your neighborhood
   transparency and open government
   increased opportunities to participate in policy-making
   improve services
   facilitate collaboration and the sharing of information
   initiatives run by interested and capable citizens
   opening up the political process
   the movement's leading preacher
   big change as inevitable
   talks hopefully of doctors being able to access information
   information on the environmental conditions of the communities
   the infrastructure of civil society

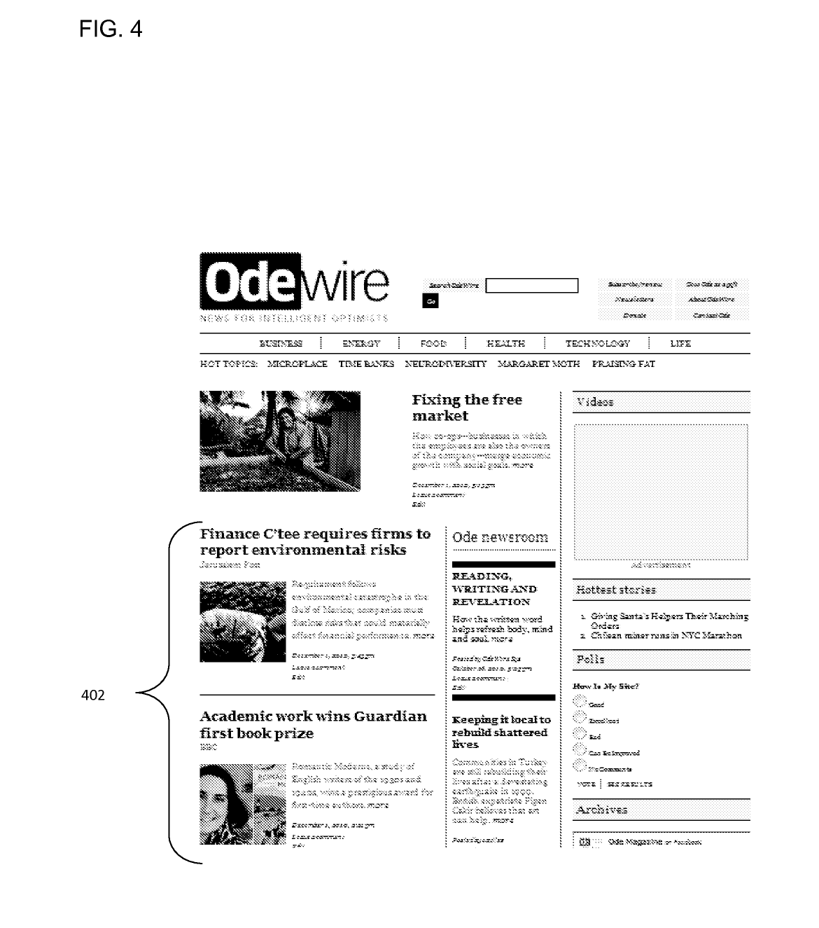

FIG. 4 shows a screen shot of the resulting OdeWire web site. The results of the embodiments are illustrated at 402. Results of the OdeWire project show that a single human curator, in approximately one to two hours per day, can curate the news from over 200 sources, which is approximately 6,000 news items daily, using the embodiment. By contrast, if human curators could comb through these at an average of 30 seconds per article, it would take 50 hours per day to peruse the lot, when done manually. Thus, the required human time has been reduced by a 25:1 ratio (which is to say, the content identification task was automated by about 96%). This result is achieved because, in a typical day, out of the 6,000 news items, the system presents only a few dozen to the curator for consideration.

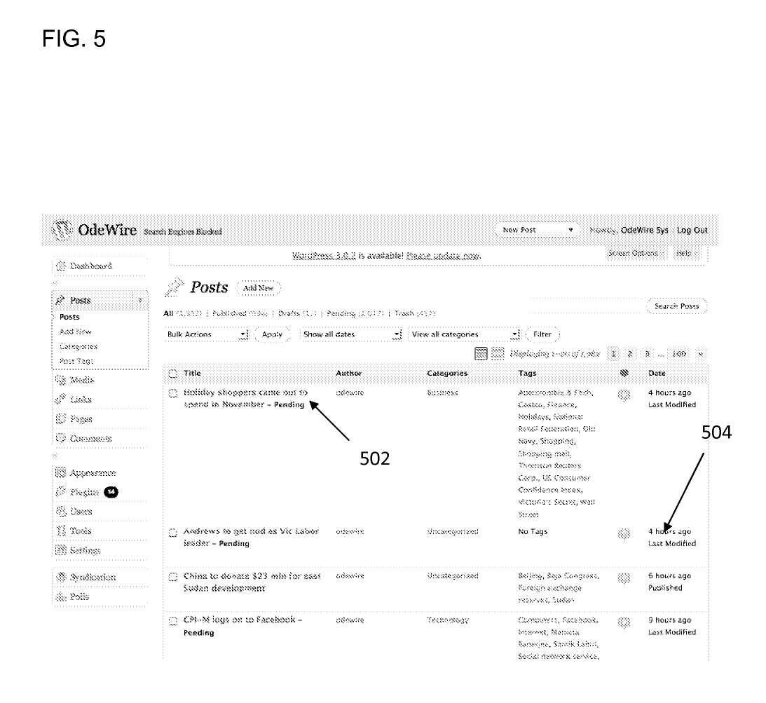

FIG. 5 illustrates the use of WordPress as the CMS for OdeWire. Within this system, the human curator can see a list of articles that have been processed by the Embodiment, review them, and change their status to Pending or Published as well as delete any that are not desired. Articles that are below a configured score threshold are set to the Pending status for review as indicated at 502. Articles that exceed this threshold are automatically set to the Published status as indicated at 504, thereby reducing the amount of human curation.

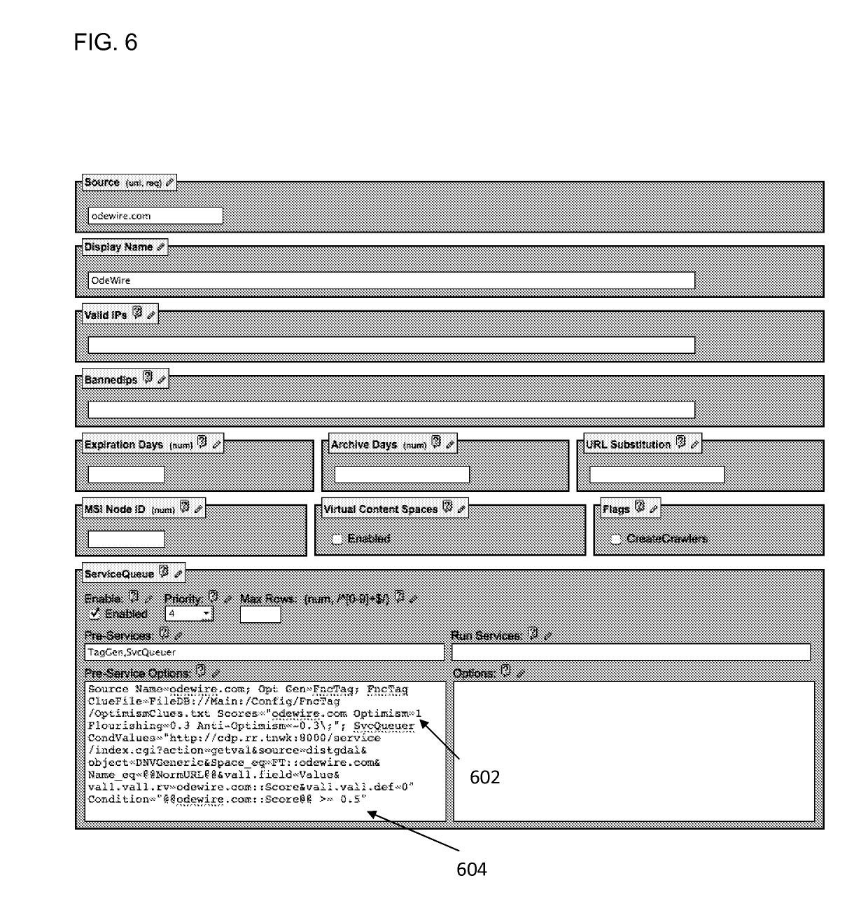

FIG. 6 shows a configuration form for adjusting the parameters of the evaluation architecture for the OdeWire prototype. Multiple stance subscores defined by the curator when configuring the analysis architecture are combined to derive a final score for each article, as shown at 602 which is then compared to a specified threshold to indicate that a given article should be included in the OdeWire document collection as shown at 604.

Embodiments have been disclosed herein. However, various modifications can be made without departing from the scope of the embodiments as defined by the appended claims and legal equivalents.

What is claimed:

1. A method for classifying a collection of digital documents based on ideological bias of authors, the method comprising:
receiving at least a portion of text of a digital document;
parsing the portion of digital text;
detecting at least one pair of specific features of the portion of digital text having specified relationships;
mapping the at least pairs of specific features to an ideological bias based on the ideological bias ontology; and
taking action on the digital document based on the ideological bias.

2. The method of claim 1, wherein the relationships are specified by an ontology.

3. The method of claim 1, wherein said mapping step comprises scoring the at least pairs with a value relating to a specified ideological bias.

4. The method of claim 2, wherein the ontology includes entities and relations and the detecting step comprises detecting at least one entity and at least one relation as the at least one pair of specific features of the portion of the digital text having specified relationships.

5. The method of claim 4, wherein the ontology includes themes, each theme having at least one entity relation pairing.

6. A computer architecture for classifying a collection of digital documents based on ideological bias of authors, the architecture comprising:
at least one processor; and
at least one memory operatively coupled to the at least one processor and storing instructions which, when executed by the processor, cause the processor to carry out the method of:
receiving at least a portion of text of a digital document;
parsing the portion of digital text;
detecting at least one pair of specific features of the portion of digital text having specified relationships;
mapping the at least pairs of specific features to an ideological bias based on the ideological bias ontology; and
taking action on the digital document based on the ideological bias.

7. The architecture of claim 6, wherein the relationships are specified by an ontology.

8. The architecture of claim 6, wherein said mapping step comprises scoring the at least pairs with a value relating to a specified ideological bias.

9. The architecture of claim 7, wherein the ontology includes entities and relations and the detecting step comprises detecting at least one entity and at least one relation as the at least one pair of specific features of the portion of the digital text having specified relationships.

10. The architecture of claim 9, wherein the ontology includes themes, each theme having at least one entity relation pairing.
